(19) United States
(12) Patent Application Publication
(10) Pub. No.: US 2025/0181014 A1
(43) Pub. Date: Jun. 5, 2025

(54) HEATING UNIT

(71) Applicant: BROTHER KOGYO KABUSHIKI KAISHA, Nagoya (JP)

(72) Inventors: Yuichi Ikeno, Maibara (JP); Yasutada Kato, Nagoya (JP)

(73) Assignee: BROTHER KOGYO KABUSHIKI KAISHA, Nagoya (JP)

(21) Appl. No.: 18/950,646

(22) Filed: Nov. 18, 2024

(30) Foreign Application Priority Data
Nov. 30, 2023 (JP) 2023-202581

(51) Int. Cl. G03G 15/20

(52) U.S. Cl. CPC G03G 15/2017; G03G 15/2039; G03G 2215/2016

(57) ABSTRACT

A fixing device includes a heater, an endless belt, a thermostat, a thermostat holder, and a film. The heater extends in a longitudinal direction and a transverse direction. The endless belt is configured to rotate around the heater, and lubricant is provided on an inner peripheral surface of the endless belt. The thermostat includes a case housing a shut-off mechanism and a heat-sensing member having a heat-sensing surface. The thermostat holder is configured to hold the case. The film is configured to cover the thermostat and the thermostat holder. The film includes a first cover portion that covers the heat-sensing surface, and a second cover portion and a third cover portion extending from the first cover portion. The second cover portion covers the heat-sensing member and the thermostat holder from one side, and the third cover portion covers the heat-sensing member and the thermostat holder from another side.

### REFERENCE TO RELATED APPLICATIONS

This application claims priority from Japanese Patent Application No. 2023-202581 filed on Nov. 30, 2023. The entire contents of the priority application are incorporated herein by reference.

### BACKGROUND ART

A fixing device known in the art for use in an image forming apparatus includes a planar heater, an endless belt that rotates around the heater, and a thermostat.

### SUMMARY

Lubricant may be provided on an inner periphery of the endless belt to reduce friction between the heater and the endless belt. When lubricant is provided on the inner periphery of the endless belt, there is a possibility that the lubricant will leak into the thermostat.

It would be desirable to provide a fixing device that restrains lubricant provided on the inner periphery surface of the endless belt leaking into the thermostat.

In one aspect, a fixing device disclosed herein comprises a heater, an endless belt, a thermostat, a thermostat holder, and a film.

The heater extends in a longitudinal direction and a transverse direction perpendicular to the longitudinal direction. The heater is plate-shaped. The endless belt rotates around the heater. Lubricant is provided on an inner peripheral surface of the endless belt. The thermostat comprises a case and a heat-sensing member. The case houses a shut-off mechanism configured to shut off power to the heater when a temperature of the shut off mechanism rises to or above a predetermined temperature. The heat-sensing member protrudes from the case. The heat-sensing member has a heat-sensing surface that detects the temperature of the heater. The thermostat holder is configured to hold the case. The film is configured to cover the thermostat and the thermostat holder. The film includes a first cover portion, a second cover portion, and a third cover portion.

The first cover portion covers the heat-sensing surface. The second cover portion extends from the first cover portion. The second cover portion covers the heat-sensing member and the thermostat holder from one side in the transverse direction. The third cover portion extends from the first cover portion. The third cover portion covers the heat-sensing member and the thermostat holder from another side in the transverse direction.

Since the film covers the thermostat and the thermostat holder, lubricant provided on the inner peripheral surface of the belt can be restrained from leaking into the thermostat.

The second cover portion and the third cover portion may be in contact with the thermostat holder.

In another aspect, a fixing device disclosed herein comprises a heater, an endless belt, a thermostat, and a film.

The heater extends in a longitudinal direction and a transverse direction perpendicular to the longitudinal direction. The heater is plate-shaped. The endless belt is configured to rotate around the heater. Lubricant is provided on an inner peripheral surface of the endless belt. The thermostat comprises a case and a heat-sensing member. The case houses a shut-off mechanism configured to shut off power to the heater when the temperature of the shut-off mechanism rises to or above a predetermined temperature. The heat-sensing member protrudes from the case. The heat-sensing member has a heat-sensing surface that detects the temperature of the heater. The film covers the thermostat. The film includes a first cover portion, a second cover portion, and a third cover portion.

The first cover portion covers the heat-sensing surface. The second cover portion extends from the first cover portion. The second cover portion covers a boundary between the heat-sensing member and the case on a side surface of the thermostat facing one side in the transverse direction. The second cover portion has a first edge extending in the longitudinal direction. The third cover portion extends from the first cover portion. The third cover portion covers a boundary between the heat-sensing member and the case on a side surface of the thermostat facing another side in the transverse direction. The third cover portion has a second edge extending in the longitudinal direction.

The first edge is positioned farther, than the boundary between the case and the heat-sensing member, from the heater in a perpendicular direction perpendicular to the longitudinal direction and the transverse direction.

The second edge is positioned father, than the boundary between the case and the heat-sensing member, from the heater in the perpendicular direction.

Since the first edge and the second edge is positioned farther, than the boundary between the case and the heat-sensing member, from the heater in the perpendicular direction perpendicular to the longitudinal direction and the transverse direction, the lubricant provided on the inner peripheral surface of the endless belt can be restrained from leaking into the thermostat.

The fixing device may further comprise a cable extending from the thermostat and a thermostat holder configured to hold the case and the cable. The second cover portion and the third cover portion may be in contact with the thermostat holder.

The film may be wrapped at least once around the thermostat as viewed from the longitudinal direction.

Since the film is wrapped at least once around the thermostat, lubricant can be restrained from leaking into the thermostat.

The dimension of the film in the longitudinal direction may be greater than a dimension of the case in the longitudinal direction.

Since the dimension of the film in the longitudinal direction is greater than the dimension of the case in the longitudinal direction, lubricant can be restrained from leaking into the thermostat.

The fixing device may comprise a heater holder configured to hold the heater and having a first opening through which the heat-sensing member extends. The dimension of the film in the longitudinal direction may be greater than a dimension of the first opening in the longitudinal direction.

Since the dimension of the film in the longitudinal direction is greater than the dimension of the first opening in the longitudinal direction, lubricant can be restrained from leaking to the heat-sensing member of the thermostat.

The heater holder may include a rib protruding toward the case at a position spaced apart from the first opening by a predetermined distance in the longitudinal direction. An end of the rib may be in contact with the film.

Since the end of the rib protruding toward case is in contact with the film, lubricant can be restrained from leaking into the thermostat 60.

The thermostat holder may include a boss that protrudes away from the heater. The film may include a first extension portion extending form the second cover portion and a second extension portion extending from the third cover portion. The first extension portion may have a first hole through which the boss extends, wherein the second cover portion may be retained on the thermostat holder by the first hole. The second extension portion may have a second hole through which the boss extends, wherein the third cover portion may be retained on the thermostat holder by the second hole.

Since the boss extends through the first hole of the first extension portion and the second hole of the second extension portion, the film can be retained on the thermostat holder.

The boss may include a recess portion that holds a spring biasing the case to press the heat-sensing surface toward the heater.

Since the boss holds the spring and the heat-sensing surface is thereby pressed toward the heater, the heat-sensing surface can stably detect the temperature of the heater.

The fixing device may further comprise a stay that supports the heater holder and has a first wall perpendicular to the transverse direction, a second wall parallel to the first wall, and a third wall connecting the first wall and the second wall. The first wall may have a through hole at a position corresponding to the thermostat in the longitudinal direction.

Since the first wall of the stay has a through hole at a position corresponding to the thermostat in the longitudinal direction, lubricant can be released outside of the stay.

The first wall may be positioned upstream of the thermostat in a direction in which the endless belt is conveyed at a position where the endless belt and the heater face each other.

Since the first wall is positioned upstream of the thermostat, lubricant upstream of the thermostat can be released outside of the stay.

The second cover portion may extend to a position farther, than the through hole, from the heater in the perpendicular direction perpendicular to the longitudinal direction and the transverse direction.

Since the second cover portion extends to a position farther, than the through hole, from the heater in the perpendicular direction, lubricant can be restrained from leaking into the thermostat.

The heater holder may have a wall extending in the longitudinal direction and positioned between the first wall and the case in the direction in which the endless belt is conveyed. The wall may have a second opening at a position corresponding to the thermostat in the longitudinal direction.

Since the wall positioned between the first wall and the case has the second opening at a position corresponding to the thermostat in the longitudinal direction, lubricant can be restrained from moving along the wall and leaking into the thermostat.

The fixing device may further comprise a cable extending from the thermostat, and the thermostat holder may be configured to hold the cable.

The film may have a lower thermal conductivity than a thermal conductivity of the heat-sensing member.

The film may be made of polyimide.

### BRIEF DESCRIPTION OF DRAWINGS

The above aspects, other advantages and further features will become more apparent by describing in detail illustrative, non-limiting embodiments thereof with reference to the accompanying drawings, in which:

FIG. 1 is a cross-sectional view of a fixing device.

FIG. 2 is an exploded perspective view of a heating unit.

FIG. 3 is a perspective view of a heater holder, a thermostat holder, a thermostat, and a film.

FIG. 4 is a perspective view of the heater holder and the thermostat as viewed from a side of the thermostat having a heat-sensing surface.

FIG. 5A is a perspective view of the thermostat and the thermostat holder covered by the film.

FIG. 5B is a perspective view of the thermostat and the thermostat holder covered by the film as viewed from an angle different from FIG. 5A.

FIG. 6 is a perspective view of the heating unit with the belt removed, showing the stay by chain double-dashed lines.

FIG. 7 is a cross-sectional view of a heater, the heater holder, the thermostat holder, and the film, taken at a central portion thereof in a transverse direction.

FIG. 8A is a cross-sectional view taken along line A-A of FIG. 7.

FIG. 8B is a development view of the film.

FIGS. 9A and 9B are illustrations corresponding to FIGS. 8A and 8B showing a heater, a heater holder, a thermostat holder, and a film according to another embodiment.

FIGS. 10A and 10B are illustrations corresponding to FIGS. 8A and 8B showing a heater, a heater holder, a thermostat holder, and a film according to another embodiment.

### DESCRIPTION

An embodiment of the present disclosure will be described in detail referring to the drawings where appropriate

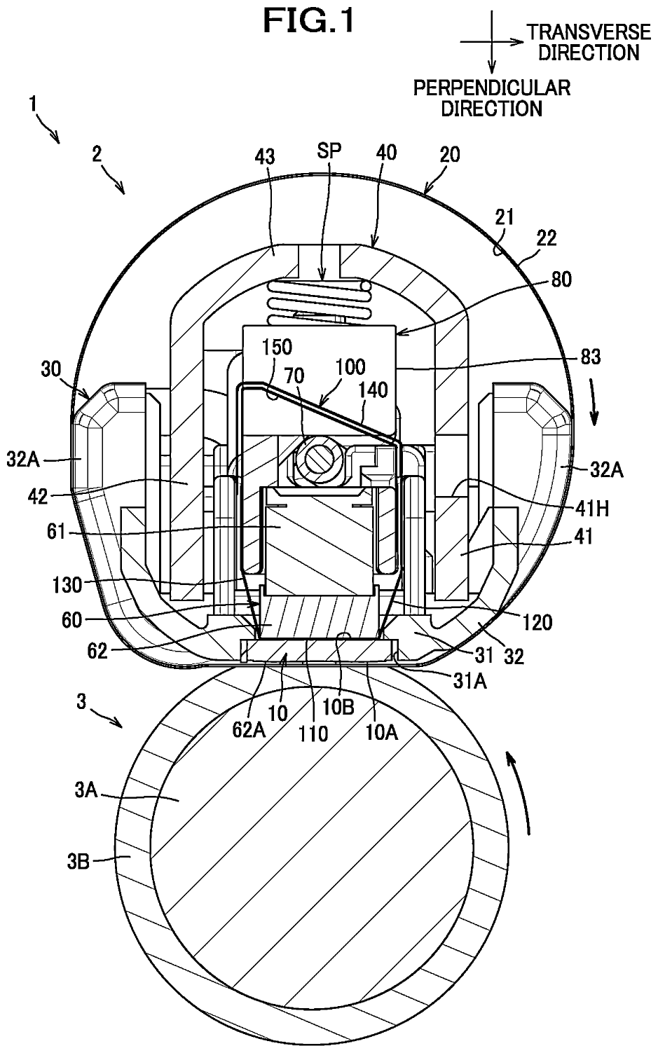

As shown in FIG. 1, a fixing device 1 is a device for use in an electrographic image forming apparatus, a foil transfer device using heat to transfer foil, etc. The fixing device 1 comprises a heating unit 2 and a pressure roller 3.

The fixing device 1, when used in an image forming apparatus, fixes a toner image onto a recording material by conveying the recording material such as paper between the heating unit 2 and the pressure roller 3. The fixing device 1, when used in a foil transfer device, transfers foil onto a recording material by conveying the recording material between the heating unit 2 and the pressure roller 3.

The heating unit 2 comprises a heater 10, a belt 20, a heater holder 30, a stay 40, and a thermostat 60.

The heater 10 heats the recording material conveyed between the heating unit 2 and the pressure roller 3. The heater 10 is a so-called ceramic heater. The heater 10 is plate-shaped. The heater 10 extends in a longitudinal direction and a transverse direction perpendicular to the longitudinal direction. In the present embodiment, the transverse direction is a direction in which the recording material is conveyed at the heater 10.

In the following description, the longitudinal direction of the heater 10 will be referred to simply as “longitudinal direction.” The transverse direction of the heater 10 will be referred to simply as “transverse direction.” The transverse direction is perpendicular to the longitudinal direction. A direction perpendicular to the longitudinal direction and the transverse direction will be referred to as “perpendicular direction.” In the drawings, the arrows indicating the directions point toward one side in each direction. The side opposite to the one side in each direction will be referred to as the other side in each direction.

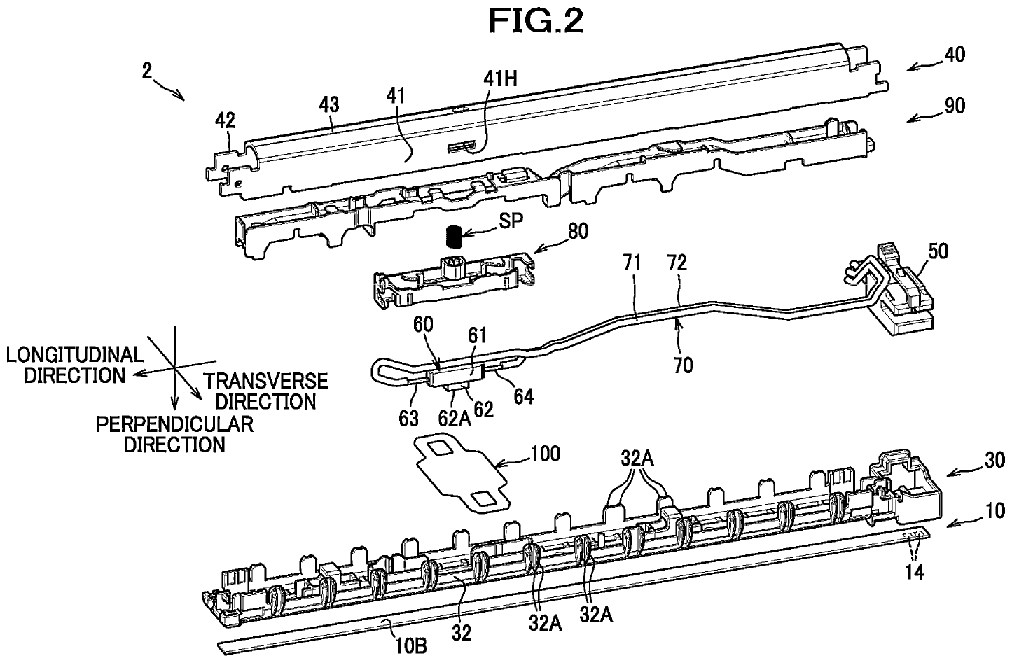

The heater 10 has a first surface 10A and a second surface 10B. The first surface 10A is a surface of the heater 10 in contact with an inner peripheral surface 21 of the belt 20, and the second surface 10B is a surface of the heater 10 opposite to the first surface 10A. A power-supply terminal 14 is provided on an end portion of the heater 10 on the other side in the longitudinal direction (refer to FIG. 2).

The belt 20 rotates around the heater 10. The belt 20 is an endless belt. The belt 20 has an inner peripheral surface 21 and an outer peripheral surface 22. The inner peripheral surface 21 of the belt 20 is in contact with the first surface 10A of the heater 10, and the outer peripheral surface 22 of the belt 20 is in contact with the pressure roller 3. The outer peripheral surface 22 of the belt 20 is also in contact with the recording material conveyed between the heating unit 2 and the pressure roller 3.

Lubricant is provided on the inner peripheral surface 21 of the belt 20. Although the specific type of lubricant is not limited, fluorinated oil based grease including thickeners and additives is used in the present embodiment.

The heater holder 30 is a member that holds the heater 10 and guides the belt 20. Specifically, the heater holder 30 supports the side of the heater 10 having the second surface 10B. In the present embodiment, the heater holder 30 is made of plastic. The heater holder 30 comprises a support wall 31 and belt guides 32.

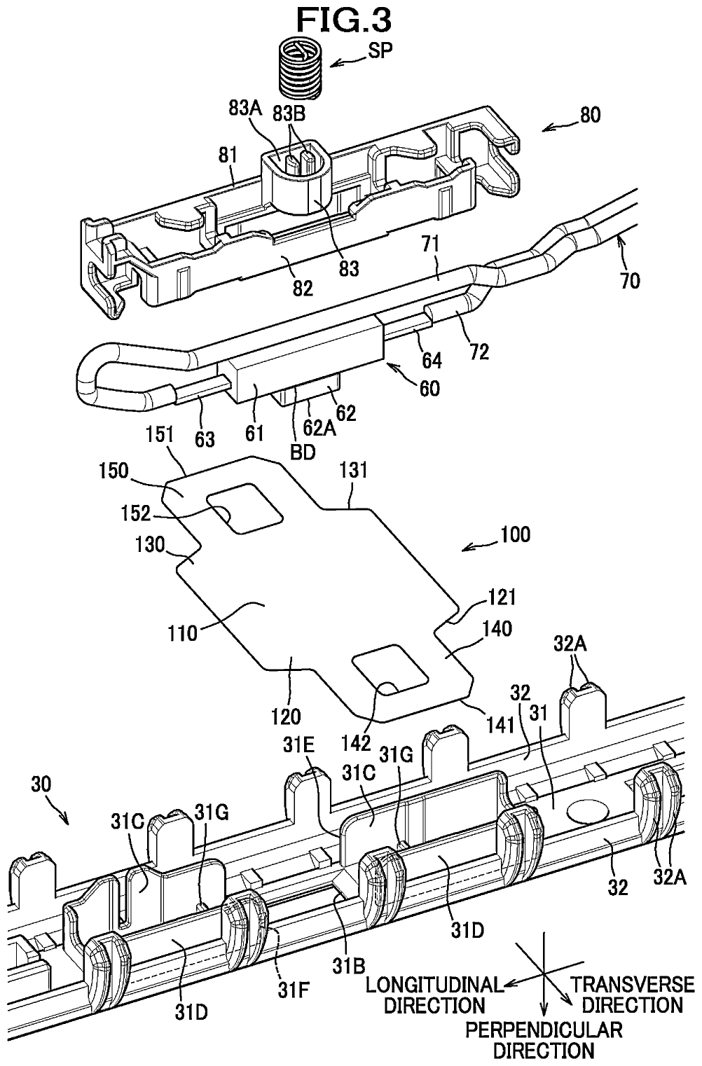

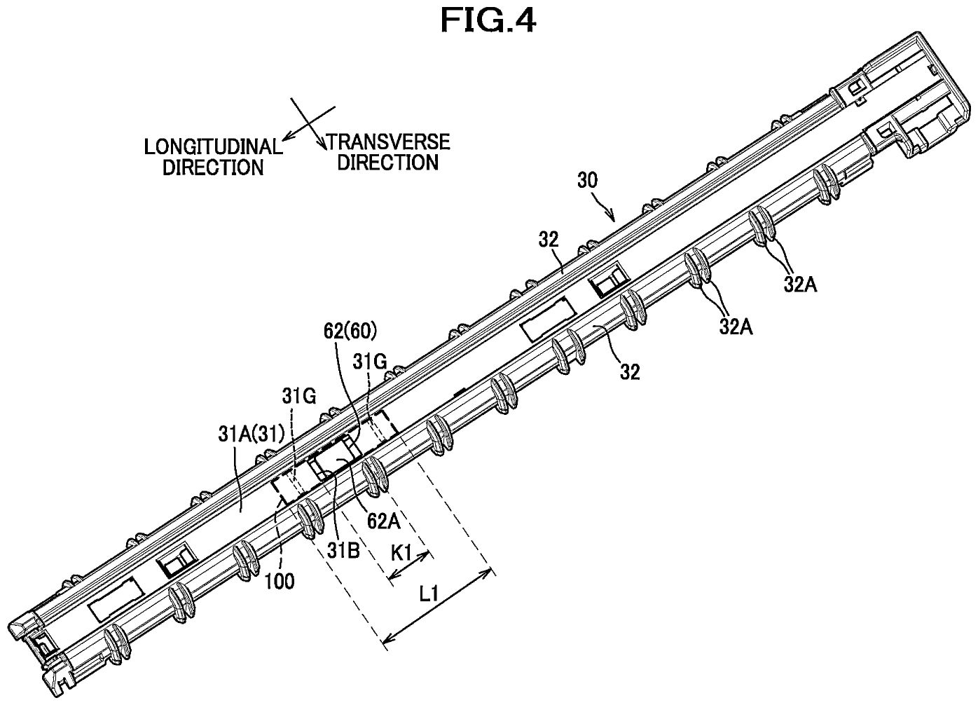

As shown in FIG. 3 and FIG. 4, the support wall 31 includes a heater positioning groove 31A, a first opening 31B, a first wall portion 31C, a second wall portion 31D, a first notch 31E, a second notch 31F as an example of a second opening, and ribs 31G.

As shown in FIG. 4, the heater positioning groove 31A extends in the longitudinal direction. The heater positioning groove 31A is a groove in which the heater 10 is to be positioned.

The first opening 31B extends through the support wall 31. The first opening 31B is a rectangular hole. In the present embodiment, a heat-sensing member 62 of a thermostat 60, which will be described below, extends through the first opening 31B.

As shown in FIG. 3, the first wall portion 31C is a wall that protrudes from the support wall 31 in a direction away from the heater 10 and extends in the longitudinal direction.

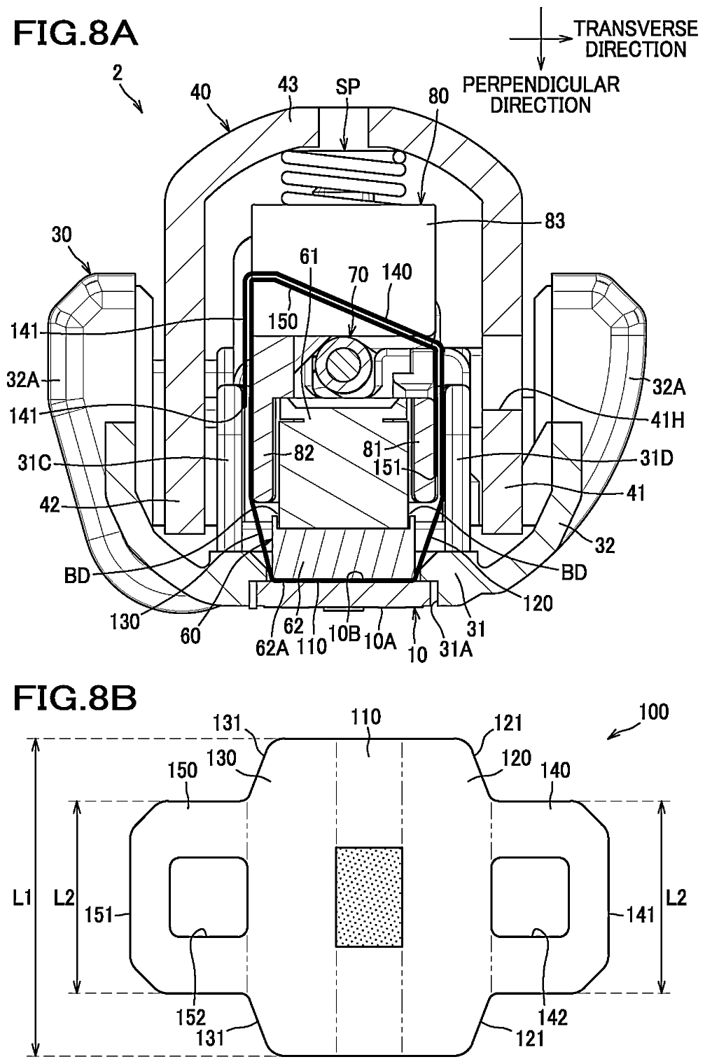

The second wall portion 31D is a wall that protrudes from the support wall 31 in a direction away from the heater 10 and extends in the longitudinal direction. The second wall portion 31D is positioned on a side of the first wall portion 31C on the one side in the transvers direction apart from the first wall portion 31C by a predetermined distance. The second wall portion 31D is an example of a wall positioned between a first wall 41 of the stay 40, which will be described below, and a case 61 in a direction in which the recording material is conveyed at a position where the heater 10 and the belt 20 face each other (refer to FIG. 8A).

The first notch 31E is formed on the first wall portion 31C. The first notch 31E is positioned at a position corresponding to the first opening 31B in the longitudinal direction. In other words, the first notch 31E is positioned at a position corresponding to the heat-sensing member 62 of the thermostat 60 in the longitudinal direction.

The second notch 31F is formed on the second wall portion 31D. The second notch 31F is positioned at a position corresponding to the first opening 31B in the longitudinal direction. In other words, the second notch 31F is positioned at a position corresponding to the heat-sensing member 62 of the thermostat 60 in the longitudinal direction.

Each rib 31G protrudes from the support wall 31 in a direction away from the heater 10, and extends in the transverse direction. The rib 31G connects the first wall portion 31C and the second wall portion 31D. Further, the rib 31G protrudes toward the case 61 of the thermostat 60, which will be described below. The rib 31G is positioned apart from the first opening 31B by a predetermined distance in the longitudinal direction. In the present embodiment, the ribs 31G are positioned at each side of the first opening 31B in the longitudinal direction.

The belt guides 32 are provided at the side of the support wall 31 facing the one side in the transverse direction and the side of the support wall 31 facing the other side in the transverse direction. Each of the belt guides 32 includes guide ribs 32A protruding in the transverse direction. The belt guide ribs 32A are aligned side by side in the longitudinal direction (refer to FIG. 2). Each of the guide ribs 32A has a shape that corresponds to the inner peripheral surface 21 of the belt 20. The inner peripheral surface 21 of the belt 20 is in contact with the guide ribs 32A. The belt 20 is allowed to rotate around the heater 10 and the heater holder 30 while being guided by the guide ribs 32A.

The stay 40 is a member that supports the heater holder 30. The stay 40 includes a first wall 41, a second wall 42, and a third wall 43.

As shown in FIG. 1, the first wall 41 is perpendicular to the transverse direction. The first wall 41 is positioned upstream of the thermostat 60 in a direction in which the belt 20 is conveyed at a position where the belt 20 and the heater 10 face each other. The first wall 41 has a through hole 41H.

The through hole 41H has a rectangular shape extending in the longitudinal direction. The through hole 41H is positioned at a central portion of the first wall 41H in the perpendicular direction. Further, as shown in FIG. 2, the through hole 41H is positioned at a position corresponding to the thermostat 60 in the longitudinal direction. Specifically, the through hole 41H is positioned at a position that overlaps the thermostat 60 as viewed from the transverse direction.

As shown in FIG. 1, the second wall 42 is a wall extending parallel to the first wall 41. The second wall 42 is positioned downstream of the thermostat 60 in the direction in which the belt 20 is conveyed at the position where the belt 20 and the heater 10 face each other. The second wall 42 is positioned on a side of the first wall 41 on the other side in the transverse direction apart from the first wall 41 by a predetermined distance.

The third wall 43 connects an edge of the first wall 41 at the other side in the perpendicular direction and the edge of the second wall 42 at the other side in the perpendicular direction.

The stay 40 supports the heater holder 30 from a side opposite to a side on which the heater 10 is positioned. Specifically, an edge of the first wall 41 at the one side in the perpendicular direction and an edge of the second wall 42 at the one side in the perpendicular direction are in contact with a surface of the support wall 31 facing opposite to a side on which the heater 10 is positioned. The stay 40 is a member having a rigidity higher than that of the plastic heater holder 30. In the present embodiment, the stay 40 is made of metal. Specifically, the stay 40 is formed by bending a steel sheet into a U-shape.

The pressure roller 3 comprises a shaft 3A and a roller body 3B. The shaft 3A is made, for example, of metal. The roller body 3B is made, for example, of rubber, and is arranged to cover the periphery of the shaft 3A. The pressure roller 3 nips the belt 20 in combination with the heater 10. In the fixing device 1, one of the heating unit 2 or the pressure roller 3 is biased toward the other.

As shown in FIG. 3, the thermostat 60 comprises a case 61, a heat-sensing member 62, a first terminal 63, and a second terminal 64.

The case 61 houses a shut-off mechanism configured to shut off power to the heater 10 when a temperature of the shut-off mechanism rises to or above a predetermined temperature.

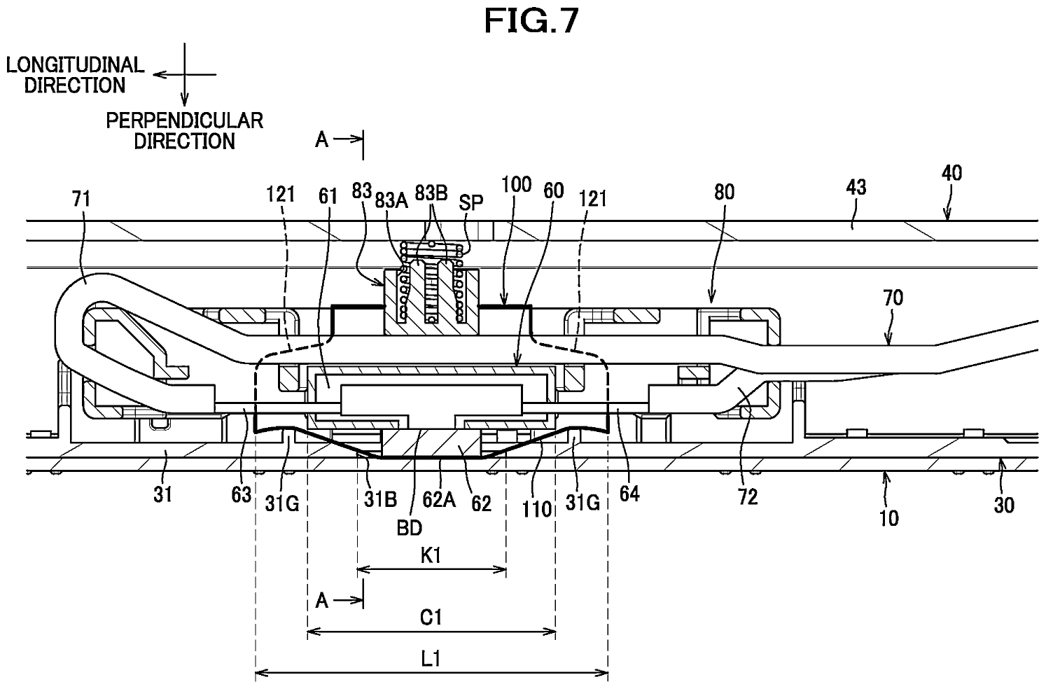

The heat-sensing member 62 protrudes from the case 61 toward the one side in the perpendicular direction. The heat-sensing member 62 comprises a bimetal positioned therein and a cap covering the bimetal. As shown in FIG. 7, the heat-sensing member 62 extends through the first opening 31B of the heater holder 30. The heat-sensing member 62 has a heat-sensing surface 62A for sensing the temperature of the heater 10 on the outer surface of the cap covering the bimetal. The heat-sensing surface 62A is a flat surface. The heat-sensing surface 62A and the second surface 10B of the heater 10 face each other. The bimetal positioned inside the heat-sensing member 62 deforms when the temperature of the heat-sensing surface 62A rises to or above a predetermined temperature which causes the shut-off mechanism to shut off power to the heater 10.

The first terminal 63 is provided on a side of the case 61 on the one side in the longitudinal direction. The second terminal 64 is provided on the other side of the case 61 on the other side in the longitudinal direction.

As shown in FIG. 2, the heating unit 2 further comprises a connector 50, a cable 70, a thermostat holder 80, a cable guide 90, a spring SP, and a film 100.

The cable 70 extends from the thermostat 60. Specifically, the cable 70 electrically connects the connector 50 and the thermostat 60. The cable 70 includes a first cable 71 and a second cable 72. The first cable 71 connects the connector 50 and the first terminal 63 of the thermostat 60. The second cable 72 connects the connector 50 and the second terminal 64 of the thermostat 60. The connector 50 supplies power to the heater 10 by contacting the power-supply terminal of the heater 10.

The thermostat holder 80 is a member that holds the thermostat 60. Specifically, the thermostat holder 80 is a member that holds the case 61 and a portion of the cable 70 of the thermostat 60.

As shown in FIG. 8A, the thermostat holder 80 is supported by the heater holder 30. Specifically, the thermostat holder 80 is positioned between the first wall portion 31C and the second wall portion 31D of the heater holder 30.

As shown in FIG. 3, the thermostat holder 80 comprises a first cover wall 81, a second cover wall 82, and a boss 83. The first cover wall 81 and the second cover wall 82 are opposed to each other in the transverse direction. As shown in FIG. 8A, the thermostat 60 is positioned between the first cover wall 81 and the second cover wall 82. In other words, the first cover wall 81 and the second cover wall 82 are opposed to the thermostat 60 in the transverse direction.

The boss 83 is a member that holds the spring SP and the cable 70. The boss 83 also retains the film 100. The boss 83 protrudes from the first cover wall 81 away from the heater 10, in other words, toward the other side in the perpendicular direction. Further, the boss 83 protrudes from a central portion of the first cover wall 81 in the longitudinal direction toward the one side in the transverse direction. As shown in FIG. 7, the cable 70 extends in the longitudinal direction on a side of the boss 83 on the one side in the perpendicular direction. Therefore, the cable 70 is held on the thermostat holder 80 by the boss 83 so that the cable 70 does not come out of the thermostat holder 80 to the other side in the perpendicular direction.

The boss 83 comprises a recess portion 83A that holds the spring SP and an engagement projection 83B. One end of the spring SP is inserted in the recess portion 83A. The engagement projection 83B is positioned inside the recess portion 83A. The engagement projection 83B protrudes away from the heater 10, i.e., toward the other side in the perpendicular direction. The engagement projection 83B is engaged with one end of the spring SP.

As shown in FIG. 2, the cable guide 90 is positioned between the heater holder 30 and the stay 40. The cable guide 90 is a member that holds the cable 70 and the thermostat holder 80.

The spring SP biases the case 61 of the thermostat 60 to press the heat-sensing surface 62A toward the heater 10. In the present embodiment, the spring SP is a compression spring. The spring SP is positioned between the stay 40 and the thermostat 60. Specifically, one end of the spring SP, which is inserted in the recess portion 83A and engaged with the engagement projection 83B is in contact with the thermostat holder 80, and the other end of the spring SP is in contact with the stay 40.

The film 100 is made of material having a thermal conductivity lower than that of the heat-sensing member 62. In the present embodiment, the film 100 is made of polyimide. The film 100 covers the thermostat 60 and the thermostat holder 80. In the present embodiment, as shown in FIG. 8A, the film is wrapped at least once around the thermostat 60, as viewed from the longitudinal direction.

As shown in FIG. 7, a dimension L1 of the film 100 in the longitudinal direction is greater than a dimension K1 of the first opening 31B in the longitudinal direction. The dimension L1 of the film 100 in the longitudinal direction is greater than a dimension C1 of the case 61 in the longitudinal direction.

As shown in FIG. 8B, the film 100 includes a first cover portion 110, a second cover portion 120, a third cover portion 130, a first extension portion 140, and a second extension portion 150.

The first cover portion 110 is a portion that covers the heat-sensing surface 62A of the thermostat 60. In FIG. 8B, the portion of the cover portion 110 that is in contact with the heat-sensing surface 62A is shown by dot-hatching. Note that FIG. 8A and FIG. 8B are not shown in equal scale. As shown in FIG. 7, an end of the rib 31G of the heater holder 30 is in contact with the film 100 (also refer to FIG. 4).

As shown in FIG. 8B, the second cover portion 120 extends from the first cover portion 110. A dimension of the second cover portion 120 in the longitudinal direction is equal to the dimension L1 of the first cover portion 110 in the longitudinal direction. As shown in FIG. 8A, the second cover portion 120 is a portion of the film 100 that covers the heat-sensing member 62 and the thermostat holder 80 from the one side in the transverse direction. The second cover portion 120 is in contact with the first cover wall 81 of the thermostat holder 80. The second cover portion 120 covers a boundary BD between the heat-sensing member 62 and the case 61 on a side surface of the thermostat 60 facing the one side in the transverse direction.

As shown in FIG. 8B, the second cover portion 120 includes first edges 121 extending in the longitudinal direction. In the present embodiment, each first edge 121 extends in a direction approximately parallel to the longitudinal direction, but the first edge 121, is slightly inclined with respect to the longitudinal direction, in such a manner that the first edge 121 is positioned closer to the first cover portion 110 as the first edge 121 extends in the longitudinal direction away from the portion that contacts the heat-sensing surface 62A shown by the dot-hatching.

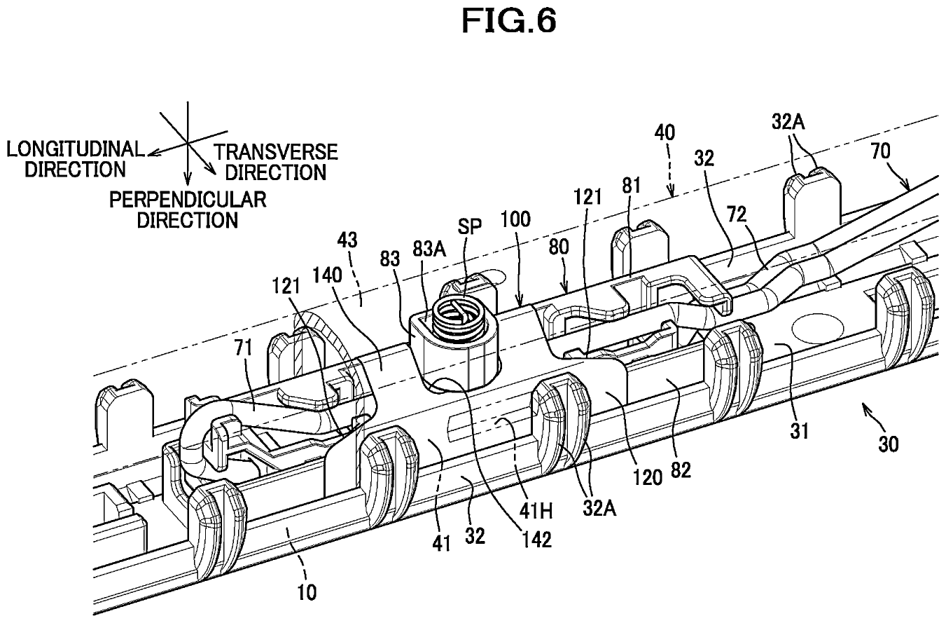

As shown in FIG. 6, the second cover portion 120 extends to a position farther, than the through hole 41H of the stay 40, from the heater 10 in the perpendicular direction. As shown in FIG. 7, the first edges 121 are positioned farther, than the boundary BD between the case 61 and the heat-sensing member 62, from the heater 10 in the perpendicular direction (also refer to FIG. 6).

As shown in FIG. 8B, the third cover portion 130 extends from the first cover portion 110. A dimension of the third cover portion 130 in the longitudinal direction is equal to the dimension L1 of the first cover portion 110 in the longitudinal direction. As shown in FIG. 8A, the third cover portion 130 is a portion of the film 100 that covers the heat-sensing member 62 and the thermostat holder 80 from the other side in the transverse direction. The third cover portion 130 is in contact with the second cover wall 82 of the thermostat holder 80. The third cover portion 130 covers the boundary BD between the heat-sensing member 62 and the case 61 on a side surface of the thermostat 60 facing the other side in the transverse direction.

As shown in FIG. 8B, the third cover portion 130 includes second edges 131 extending in the longitudinal direction. In the present embodiment, each second edge 131 extends in a direction approximately parallel to the longitudinal direction, but the second edge 131, is slightly inclined with respect to the longitudinal direction, in such a manner that the second edge 131 is positioned closer to the first cover portion 110 as the second edge 131 extends in the longitudinal direction away from the portion that contacts the heat-sensing surface 62A shown by the dot-hatching.

As shown in FIG. 8B, the first extension portion 140 extends from the second cover portion 120. A dimension L2 of the first extension portion 140 in the longitudinal direction is smaller than the dimension L1 of the second cover portion 120 in the longitudinal direction. The first extension portion 140 includes a third edge 141 and a first hole 142.

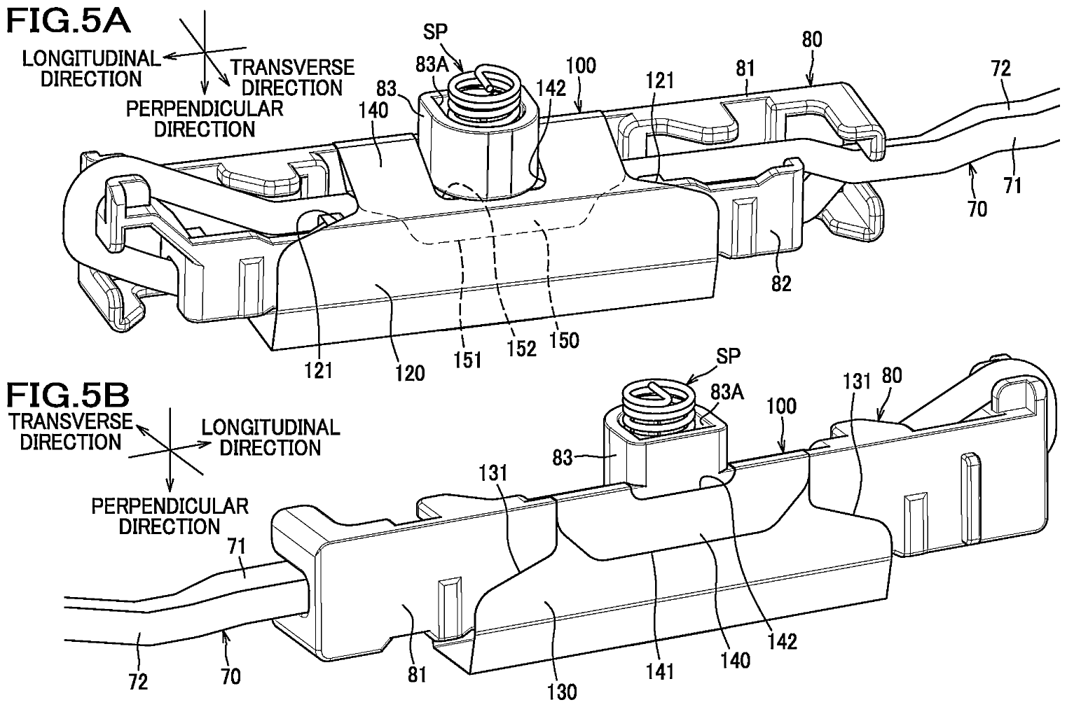

The third edge 141 extends in the longitudinal direction. The first hole 142 is a rectangular hole formed at a central portion of the first extension portion 140 in the longitudinal direction. As shown in FIG. 5A, the boss 83 extends through the first hole 142. The first hole 142 retains the second cover portion 120 on the thermostat holder 80.

As shown in FIG. 8B, the second extension portion 150 extends from the third cover portion 130. The dimension L2 of the second extension portion 150 in the longitudinal direction is smaller than the dimension L1 of the third cover portion 130 in the longitudinal direction. The second extension portion 150 includes a fourth edge 151 and a second hole 152.

The fourth edge 151 extends in the longitudinal direction. The second hole 152 is a rectangular hole formed at a central portion of the second extension portion 150 in the longitudinal direction. As shown in FIG. 5A, the boss 83 extends through the second hole 152. The second hole 152 retains the third cover portion 130 on the thermostat holder 80.

Here, the process of assembling the thermostat 60 into the fixing device 1 will be described.

As shown in FIG. 3, when assembling the thermostat 60 to the fixing device 1, first, the thermostat 60 is inserted into the thermostat holder 80. Then, the cable 70 is placed in a predetermined position on the thermostat holder 80.

Next, as shown in FIG. 5A and FIG. 5B, the film 100 is attached to the thermostat 60 and the thermostat holder 80. In this case, first, the boss 83 is inserted into the second hole 152 of the second extension portion 150. Then, the film 100 is wrapped around the thermostat 60 and the thermostat holder 80 so that the first cover portion 110 contacts the heat-sensing surface 62A, and then the boss 83 is inserted into the first hole 142 of the first extension portion 140. Thereby, the film 100 is attached to the thermostat 60 and the thermostat holder 80.

Next, as shown in FIG. 7, the thermostat 60 and the thermostat holder 80 with the film 100 attached thereto is placed in the heater holder 30. The heater 10 may be assembled on the heater holder 30 beforehand, or the heater 10 may be assembled on the heater holder 30 afterwards.

Next, the stay 40 is attached to the heater holder 30. When the stay 40 is attached to the heater holder 30, the spring SP positioned between the stay 40 and the thermostat 60 biases the thermostat 60 toward the heater 10. The heat-sensing surface 62A of the thermostat 60 is thereby pressed against the second surface 10B of the heater 10, and the ends of the ribs 31G are pressed against the film 100.

Next, advantageous effects obtained by the fixing device 1 of the present embodiment will be described.

In the fixing device 1 according to the present embodiment, lubricant is provided on the inner peripheral surface 21 of the belt 20. If this lubricant leaks into the thermostat 60, the thermostat 60 may not operate properly. However, since the film 100 covers the thermostat 60 and the thermostat holder 80 in the fixing device 1, the lubricant provided on the inner peripheral surface 21 of the belt 20 can be restrained from leaking into the thermostat 60.

As shown in FIG. 7, the first edges 121 and the second edges 131 of the film 100 are positioned farther, than the boundary BD between the case 61 and the heat-sensing member 62 of the thermostat 60, from the heater 10 in the perpendicular direction. Thus, lubricant provided on the inner peripheral surface 21 of the belt 20 can be restrained from leaking into the thermostat 60.

As shown in FIG. 8A, since the film 100 is wrapped at least once around the thermostat 60, lubricant can be restrained from leaking into the thermostat 60.

Since the dimension L1 of the film 100 in the longitudinal direction is greater than the dimension C1 of the case 61 in the longitudinal direction, lubricant can be restrained from leaking into the thermostat 60.

As shown in FIG. 4, since the dimension L1 of the film 100 in the longitudinal direction is greater than the dimension K1 of the first opening 31B in the longitudinal direction, lubricant can be restrained from leaking to the heat-sensing member 62 of the thermostat 60.

As shown in FIG. 7, since the end of the rib 31G protruding toward the case 61 of the thermostat 60 is in contact with the film 100, lubricant can be restrained from leaking into the thermostat 60.

Since the boss 83 of the thermostat holder 80 extends through the first hole 142 of the first extension portion 140 of the film 100 and the second hole 152 of the second extension portion 150 of the film 100, the film 100 can be retained on the thermostat holder 80 without using adhesives or double-sided tapes.

Since the boss 83 of the thermostat holder 80 holds the spring SP, the heat-sensing surface 62A of the thermostat 60 is pressed toward the heater 10. Thus, the heat-sensing surface 62A can stably detect the temperature of the heater 10.

Since the first wall 41 of the stay 40 has the through hole 41H at a position corresponding to the position of the thermostat 60 in the longitudinal direction, lubricant can be released outside of the stay 40. Thus, lubricant can be restrained from leaking into the thermostat 60.

Since the first wall 41 of the stay 40 is positioned upstream of the thermostat 60, lubricant provided upstream of the thermostat 60 can be released outside of the stay 40 through the through hole 41H.

The second cover portion 120 of the film 100 extends to a position farther, than the through hole 41H of the stay 40, from the heater 10 in a perpendicular direction. Thus, lubricant can be restrained from leaking into the thermostat 60.

The second wall portion 31D positioned between the first wall 41 of the stay 40 and the case 61 of the thermostat 60 has the second notch 31F positioned at a position corresponding to the thermostat 60 in the longitudinal direction. Thus, lubricant can be restrained from moving along the second wall portion 31D toward the other side in the perpendicular direction, and lubricant can be restrained from leaking into the thermostat 60.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

Although the film 100 is wrapped at least once around the thermostat 60 as viewed from the longitudinal direction in the above-described embodiment, a film may not be wrapped at least once around the thermostat.

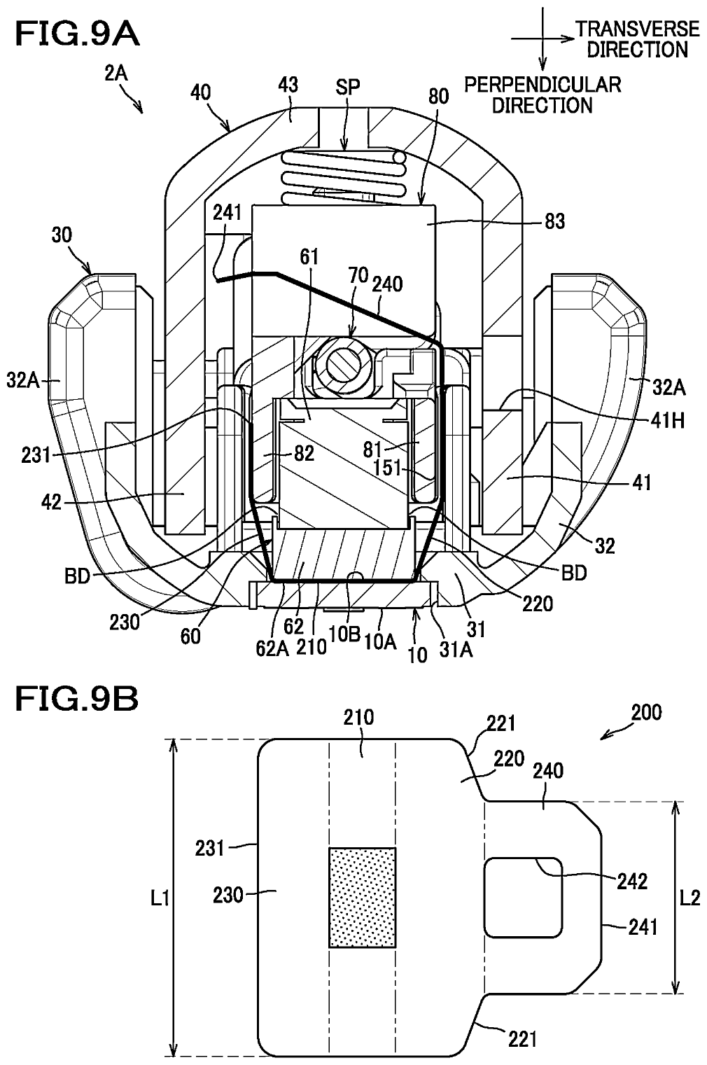

For example, a film 200 shown in FIGS. 9A and 9B is not wrapped at least once around the thermostat 60. As shown in FIGS. 9A and 9B, the film 200 comprises a first cover portion 210, a second cover portion 220, a third cover portion 230, and a first extension portion 240. The second cover portion 220 has first edges 221 extending in the longitudinal direction. The third cover portion 230 has a second edge 231 extending in the longitudinal direction. The first extension portion 240 has a third edge 241 and a first hole 242. The film 200 retains the second cover portion 220 on the thermostat holder 80 by the first hole 242 receiving the boss 83. The third cover portion 230 is fixed onto the second cover wall 82 by an adhesive.

Since this film 200 also covers the thermostat 60 and the thermostat holder 80, lubricant provided on the inner peripheral surface 21 of the belt 20 can be restrained from leaking into the thermostat 60.

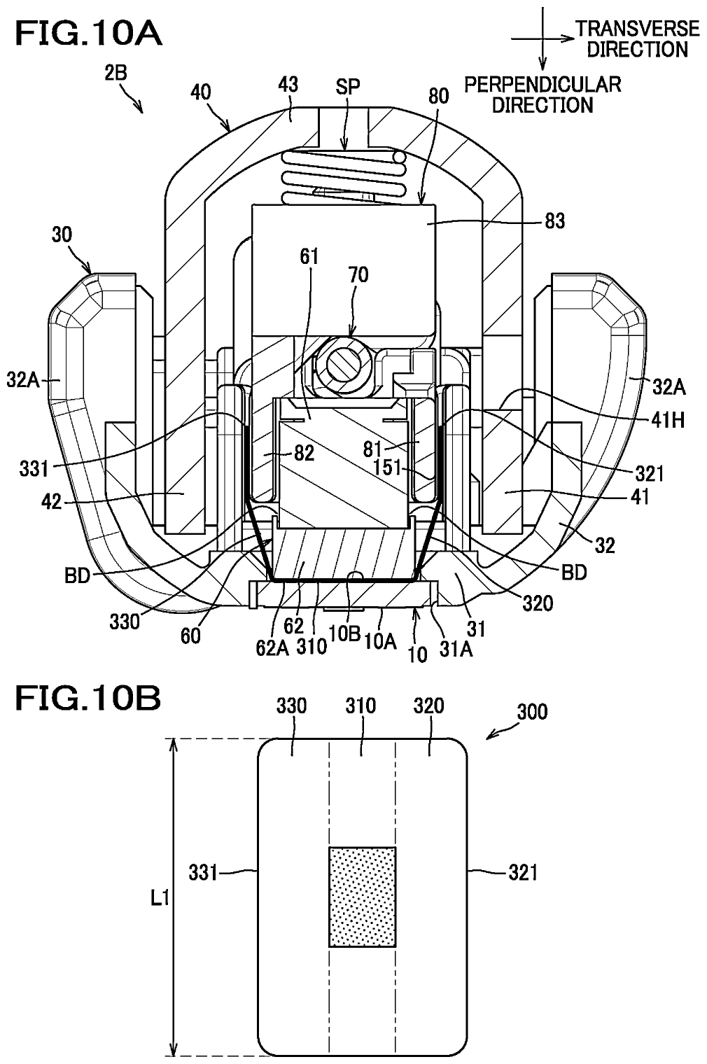

For example, a film 300 shown in FIGS. 10A and 10B is not wrapped at least once around the thermostat 60. As shown in FIGS. 10A and 10B, the film 300 comprises a first cover portion 310, a second cover portion 320, and a third cover portion 330. The second cover portion 320 has a first edge 321 extending in the longitudinal direction. The third cover portion 330 has a second edge 331 extending in the longitudinal direction. The second cover portion 320 and the third cover portion 330 are fixed onto the first cover wall 81 and the second cover wall 82 by an adhesive.

Since this film 300 also covers the thermostat 60 and the thermostat holder 80, lubricant provided on the inner peripheral surface 21 of the belt 20 can be restrained from leaking into the thermostat 60.

Although the heat-sensing member 62 extends through the first opening 31B of the heater holder 30 in the above-described embodiment, the heat-sensing member 62 may not extend through the first opening 31B if the heat-sensing member 62 is capable of detecting the temperature of the heater 10. For example, the heat-sensing member 62 may extend into the first opening 31B with the heat-sensing surface 62A not reaching the heater 10. A heat-transfer member that transfers heat well may be provided between the heat-sensing member 62 and the heater 10.

Although the thermostat 60 includes bimetal inside, and the bimetal deforms when the temperature of the heat-sensing surface 62A rises to or above a predetermined temperature which causes the shut-off mechanism to shut off power to the heater in the above-described embodiment, the thermostat may include a fuse inside. According to this configuration, the metal of the fuse melts and power to the heater is shut off when the temperature rises to or above a predetermined temperature.

Although the thermostat holder 80 holds the case 61 and a part of the cable 70 of the thermostat 60 in the above-described embodiment, the thermostat holder may be configured to hold only the case 61 of the thermostat 60.

Although the film 100 is wrapped at least once around the thermostat 60 as viewed from the longitudinal direction in the above-described embodiment, the film 100 may be wrapped at least twice around the thermostat as viewed from the longitudinal direction.

Although the second notch 31F is given as an example of the second opening in the above-described embodiment, the second opening may be a through hole or a groove.

Although the biasing member biasing the thermostat 60 toward the heater 10 is the spring SP in the above-described embodiment, the biasing member may, for example, be a helical torsion spring or a leaf spring.

Although the film 100 is made of polyimide in the above-described embodiment, the film 100 may, for example, be made of fluoroplastics, polyethylene terephthalate (PET), or other plastics, or material other than plastic.

The elements described in the above embodiment and its modified examples may be implemented selectively and in combination.

What is claimed is:

1. A fixing device comprising:
a plate-shaped heater extending in a longitudinal direction and a transverse direction perpendicular to the longitudinal direction;
an endless belt configured to rotate around the heater with lubricant being provided on an inner peripheral surface of the endless belt;
a thermostat comprising:
a case that houses a shut-off mechanism that is configured to shut off power to the heater when a temperature of the shut-off mechanism rises to or above a predetermined temperature; and
a heat-sensing member protruding from the case, the heat-sensing member having a heat-sensing surface that detects the temperature of the heater;
a thermostat holder configured to hold the case; and
a film configured to cover the thermostat and the thermostat holder,
wherein the film includes:
a first cover portion that covers the heat-sensing surface;
a second cover portion that extends from the first cover portion, the second cover portion covering the heat-sensing member and the thermostat holder from one side in the transverse direction; and
a third cover portion that extends from the first cover portion, the third cover portion covering the heat-sensing member and the thermostat holder from another side in the transverse direction.

2. The fixing device according to claim 1, wherein the second cover portion and the third cover portion are in contact with the thermostat holder.

3. A fixing device comprising:
a plate-shaped heater extending in a longitudinal direction and a transverse direction perpendicular to the longitudinal direction;
an endless belt configured to rotate around the heater with lubricant being provided on an inner peripheral surface of the endless belt;
a thermostat comprising:
a case that houses a shut-off mechanism that is configured to shut off power to the heater when a temperature of the heater rises to or above a predetermined temperature; and
a heat-sensing member protruding from the case, the heat-sensing member having a heat-sensing surface that detects the temperature of the heater; and
a film that covers the thermostat,
wherein the film includes:
a first cover portion that covers the heat-sensing surface;
a second cover portion that extends from the first cover portion, the second cover portion covering a boundary between the heat-sensing member and the case on a side surface of the thermostat facing one side in the transverse direction, the second cover portion having a first edge extending in the longitudinal direction; and
a third cover portion that extends from the first cover portion, the third cover portion covering a boundary between the heat-sensing member and the case on a side surface of the thermostat facing another side in the transverse direction, the third cover portion having a second edge extending in the longitudinal direction,
wherein the first edge is positioned farther, than the boundary between the case and the heat-sensing member, from the heater in a perpendicular direction perpendicular to the longitudinal direction and the transverse direction, and
wherein the second edge is positioned farther, than the boundary between the case and the heat-sensing member, from the heater in the perpendicular direction.

4. The fixing device according to claim 3, further comprising:
a cable extending from the thermostat; and
a thermostat holder configured to hold the case and the cable,
wherein the second cover portion and the third cover portion are in contact with the thermostat holder.

5. The fixing device according to claim 1, wherein the film is wrapped at least once around the thermostat, as viewed from the longitudinal direction.

6. The fixing device according to claim 1, wherein a dimension of the film in the longitudinal direction is greater than a dimension of the case in the longitudinal direction.

7. The fixing device according to claim 1, further comprising a heater holder configured to hold the heater, the heater holder having a first opening through which the heat-sensing member extends, wherein a dimension of the film in the longitudinal direction is greater than a dimension of the first opening in the longitudinal direction.

8. The fixing device according to claim 7, wherein the heater holder includes a rib protruding toward the case at a position spaced apart from the first opening by a predetermined distance in the longitudinal direction,
wherein an end of the rib is in contact with the film.

9. The fixing device according to claim 1,
wherein the thermostat holder includes a boss that protrudes away from the heater, and
wherein the film includes:
a first extension portion that extends from the second cover portion, the first extension portion having a first hole through which the boss extends, the second cover portion being retained on the thermostat holder by the first hole; and
a second extension portion that extends from the third cover portion, the second extension portion having a second hole through which the boss extends, the third cover portion being retained on the thermostat holder by the second hole.

10. The fixing device according to claim 9, wherein the boss includes a recess portion that holds a spring, and the spring biases the case to press the heat-sensing surface toward the heater.

11. The fixing device according to claim 7, further comprising a stay configured to support the heater holder, the stay having a first wall perpendicular to the transverse direction, a second wall parallel to the first wall, and a third wall connecting the first wall and the second wall,
wherein the first wall has a through hole at a position corresponding to the thermostat in the longitudinal direction.

12. The fixing device according to claim 11, wherein the first wall is positioned upstream of the thermostat in a direction in which the endless belt is conveyed at a position where the endless belt and the heater face each other.

13. The fixing device according to claim 11, wherein the second cover portion extends to a position farther, than the through hole, from the heater in a perpendicular direction perpendicular to the longitudinal direction and the transverse direction.

14. The fixing device according to claim 12,
wherein the heater holder includes a wall extending in a longitudinal direction, the wall being positioned between the first wall and the case in the direction in which the endless belt is conveyed, and
wherein the wall has a second opening at a position corresponding to the thermostat in the longitudinal direction.

15. The fixing device according to claim 1, further comprising a cable extending from the thermostat, wherein the thermostat holder is configured to hold the cable.

16. The fixing device according to claim 1, wherein a thermal conductivity of the film is lower than a thermal conductivity of the heat-sensing member.

17. The fixing device according to claim 1, wherein the film is made of polyimide.
